(19) United States
(12) Patent Application Publication
(10) Pub. No.: US 2011/0066906 A1
(43) Pub. Date: Mar. 17, 2011

(54) Pulse Triggered Latches with Scan Functionality

(75) Inventor: Robin Jui-Pin Tang, San Jose, CA (US)

(73) Assignee: LSI Corporate

(21) Appl. No.: 12/558,754

(22) Filed: Sep. 14, 2009

(51) Int. Cl. G06F 11/28

(52) U.S. Cl. 714/731; 714/E11.178

(57) ABSTRACT

Described embodiments provide a scan chain including at least one pulse-triggered latch scan cell. The pulse-triggered latch scan cell includes a pulse-triggered latch adapted to latch data present at its input terminal to its output terminal based on a clock pulse applied to its clock terminal. A pulse generator is adapted to generate the clock pulse from either a rising edge or a falling edge of a clock signal, and the pulse generator includes a logic circuit adapted to generate either a rising edge-generated clock pulse or a falling edge-generated clock pulse based on a control signal.

### BACKGROUND OF THE INVENTION

1. Field of the Invention

The present invention relates generally to logic circuits for storage devices, and, in particular, to pulse triggered latches with scan functionality.

2. Description of the Related Art

Digital circuits, such as microprocessors and memory devices, often use flip-flops as temporary storage elements. In integrated circuits (ICs), for example, many field-programmable gate arrays (FPGAs) employ flip-flops as counters and shift registers.

Flip-flops are used in a sequential circuit configuration to store state information. A typical flip-flop has data input/output and clock signal terminals (hereinafter a “data input,” a “clock input,” and a “data output”). Data at the data input is sampled, and provided at the data output, at predetermined times, typically defined by rising or falling edges of a clock signal provided at the clock input. In general, a flip-flop comprises two logic devices called latches. Typically, to reliably sample the input signal, a flip-flop requires an input signal level to be relatively stable for a defined minimum duration (termed “setup time”) before a clock edge occurs that is used for timing to sample the input data. Similarly, flip-flops also require the sampled input signal to remain stable after the clock edge for a defined duration (termed “hold time”).

As shown in FIG. 1a, two conventional latches might be coupled in series to form master-slave flip-flop 100. In a case where flip-flop 100 is a positive edge-triggered flip-flop, a clock-low enabled master latch is followed by a clock-high enabled slave latch, and vice-versa for a negative edge-triggered flip-flop. Flip-flop 100 comprises master latch 101 and slave latch 102. Clock signal (or “clock”) 104 is provided to master latch 101 at input CLK and to inverter 107. Master latch 101 also receives data input signal 103 at input D, and provides output signal 105 at output Q and, optionally, inverted output signal 106 at Q̅. Output signals 105 and 106 at Q and Q̅, respectively, of master latch 101 cannot change state except on a positive transition (positive edge-triggered) or on a negative transition (negative edge-triggered) of clock signal 104, regardless of the value of data input signal 103 at input D. Output signal 105 is provided to data input node D of slave latch 102. Inverter 107 provides inverted clock signal 108 to slave latch 102 at node CLK. Slave latch 102 provides output signal 110 at Q and, optionally, inverted output signal 111 at Q̅. Output signals 110 and 111 at Q and Q̅, respectively, of slave latch 102 cannot change state except on a negative transition (when flip-flop 100 is positive edge-triggered) of inverted clock signal 108 or on a positive transition (when flip-flop 100 is negative edge-triggered) of inverted clock signal 108, regardless of the value of data input signal 105 at node D of slave latch 102. Output signal 110 of slave latch 102 is provided as the output of flip-flop 100.

FIG. 1b shows a timing diagram of the input, clock and output signals of flip-flop 100. For example, as shown in FIG. 1b, when flip-flop 100 is positive-edge triggered, output 105 of master latch 101 stores the input data value 103 when clock signal 104 transitions from low to high (shown at transition 114). Shaded areas 113 and 115 represent “don't care” areas of the timing diagram. For example, on circuit startup, the output signals might not be in a known state until one or more clock cycles allow known input data to be latched to the outputs 105 and 110. Inverted clock signal 108 provided to slave latch 102 is logic zero, preventing slave latch 102 from storing the data value of signal 105 at its input node, D. At transition 115, when clock signal 104 goes low (logic zero), inverted clock signal 108 goes high (logic one), and the data value stored in master latch 101 as signal 105 at node Q is stored by slave latch 102 as output 110 at its node Q. When clock signal 108 returns to logic zero, clock signal 104 goes to logic one (shown at transition 116), and master latch 101 latches the value of signal 103 at D to its output 105 at Q as described above, and so on, for subsequent transitions of clock signals 104 and 108. As would be understood by one skilled in the art, when it is negative-edge triggered, flip-flop 100 functions similarly as described above but for the inverse transitions of clock signals 104 and 108.

Logic circuits such as, for example, memory devices employing flip-flops, might employ automatic test-pattern generation (ATPG) and a scan chain to perform a scan test of the logic circuit. For example, ATPG might be employed to apply known signals (test vectors) to the logic circuit and to observe the output to determine whether the logic circuit functions properly or has a defect. A circuit block including a multiplexer and a flip-flop, with the multiplexer having a test vector input, a scan enable input, a normal data input, and an output interconnected to the input of a flip-flop, is often called a scan flip-flop or scan cell. A scan chain might be implemented by connecting one or more scan cells together, effectively forming a shift register. As shown in FIG. 2a, scan chain 220 might generally comprise a plurality of scan cells adapted to test data output from a plurality of flip-flops in a logic circuit. Scan chain 220 provides a way to apply test vectors to the logic circuit and observe the output of multiple scan cells in the circuit by reading the values in the shift register. For example, scan chain 220 might include scan cell 200A and scan cell 200B, which might be implemented by scan cells as shown in FIG. 2b. As shown, both scan cell 200A and scan cell 200B receive scan enable signal 203 and clock signal 204. Scan cell 200A receives data signal 201A and test vector signal 202A, and provides output signal 208A.

In normal operation mode, output signal 208A is provided to logic block 222. Logic block 222 might be one or more combinatorial logic blocks. The output of logic block 222 is provided as data input signal 201B to scan cell 200B. In scan test mode, scan chain 220 might be configured to bypass logic block 222. As shown in FIG. 2a, during scan tests output signal 208A of scan cell 200A is provided as test vector input signal 202B. Scan cell 200B provides output signal 208B. Output signal 208B of scan cell 200B might be provided to a subsequent scan cell (not shown) of scan chain 220. As would be appreciated by one skilled in the art, bypassing one or more logic blocks, such as logic block 222, during a scan test might allow signals to propagate very quickly between scan cells, potentially causing hold-time violations.

FIG. 2b shows additional detail of scan cells 200A and 200B of FIG. 2a. Scan cell 200 includes multiplexer 205 and flip-flop 207. Flip-flop 207 might be implemented as a flip-flop such as shown in FIG. 1a. Multiplexer 205 receives data signal 201, test vector signal 202, scan enable signal 203 and clock signal 204. Output 206 of multiplexer 205 is in communication with input node D of flip-flop 207. Scan enable signal 203 is employed to allow multiplexer 205 to select between two modes of operation for flip-flop 207: scan test mode and normal operation mode. During a scan test, scan enable signal 203 is configured such that multiplexer 205 outputs test vector signal 202, and during normal operation, scan enable input 203 is configured such that multiplexer 205 outputs data signal 201. Therefore, flip-flop 207 can only receive one of data signal 201 or test vector signal 202, but not both simultaneously. Scan cell 200 provides output signal 208, which is in communication with the output node of flip-flop 207.

As shown in FIG. 1a, master-slave flip-flop 100 includes two latches such that input data does not flow through from input 103 to output 110 in one clock cycle. Since flip-flop 100 has two latches, it consumes more power than a single latch. Thus, chip designers sometimes replace master-slave flip-flops with single latches to reduce power consumption of a chip. However, unlike master-slave flip-flop 100, a single latch allows input data to flow through in one clock cycle, for example, from input signal 103 to output signal 105. Thus, a single latch would be “data transparent,” and difficult to analyze in a scan chain. Further, conventional latches are generally sensitive to propagation delays on the clock signal, and variations in chip layout might cause propagation delays in the clock signal.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In an exemplary embodiment, the present invention provides a scan chain including at least one pulse-triggered latch scan cell. The pulse-triggered latch scan cell includes a pulse-triggered latch adapted to latch data present at its input terminal to its output terminal based on a clock pulse applied to its clock terminal. A pulse generator is adapted to generate the clock pulse from either a rising edge or a falling edge of a clock signal, and the pulse generator includes a logic circuit adapted to generate either a rising edge-generated clock pulse or a falling edge-generated clock pulse based on a control signal.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1a shows a master-slave flip-flop in accordance with the prior art;

FIG. 1b shows a timing diagram for the master-slave flip-flop of FIG. 1a;

FIG. 2a shows a scan cell in accordance with the prior art;

FIG. 2b shows a scan chain in accordance with the prior art;

FIG. 3a shows a pulse-triggered D-latch, in accordance with an exemplary embodiment of the present invention;

FIG. 3b shows a timing diagram for the circuit of FIG. 3a;

FIG. 4a shows a pulse-triggered latch as shown in FIG. 3a with scan functionality, in accordance with an exemplary embodiment of the present invention;

FIG. 4b shows a scan chain implemented with pulse-triggered latches as shown in FIG. 4a, in accordance with an exemplary embodiment of the present invention;

FIG. 5 shows an alternative embodiment of the scan chain of FIG. 4b;

FIG. 6a shows a schematic of a pulse generator, in accordance with an embodiment of the present invention;

FIG. 6b shows a truth table for the pulse generator of FIG. 6a; and

FIG. 7 shows a timing diagram for the pulse generator of FIG. 6a.

### DETAILED DESCRIPTION

In accordance with embodiments of the present invention a pulse-triggered latch cell having a single latch with scan functionality is provided for a scan chain. A pulse-triggered latch in accordance with the teachings herein generally prevents input data flow through in one clock cycle, allowing for improved analysis in a scan chain while generally decreasing power dissipation of the latch cell and sensitivity to propagation delays on a clock signal employed by the latch caused by, for example, variations in integrated circuit (IC) chip layout.

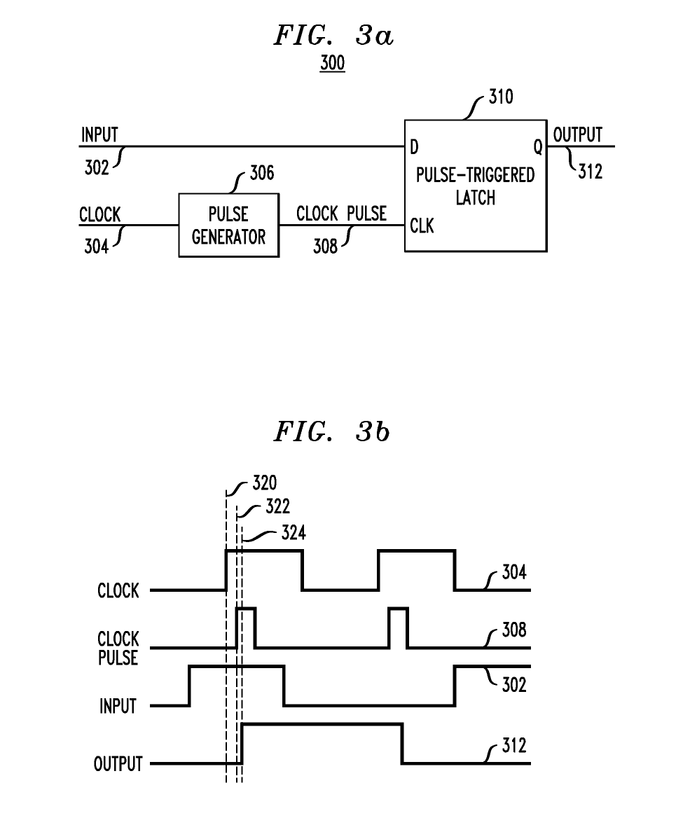

FIG. 3a shows pulse-triggered latch cell 300 operating in accordance with embodiments of the present invention. As shown, pulse-triggered latch cell 300 includes pulse-triggered latch 310 and pulse generator 306. Pulse generator 306 receives clock signal 304, which might be the same clock signal provided to other digital circuits located within an IC including pulse-triggered latch cell 300. Based on clock signal 304, pulse generator 306 generates pulse signal 308. Pulse-triggered latch 310 receives input signal 302 at node D and pulse signal 308 at clock input node CLK, and provides output signal 312 at node Q.

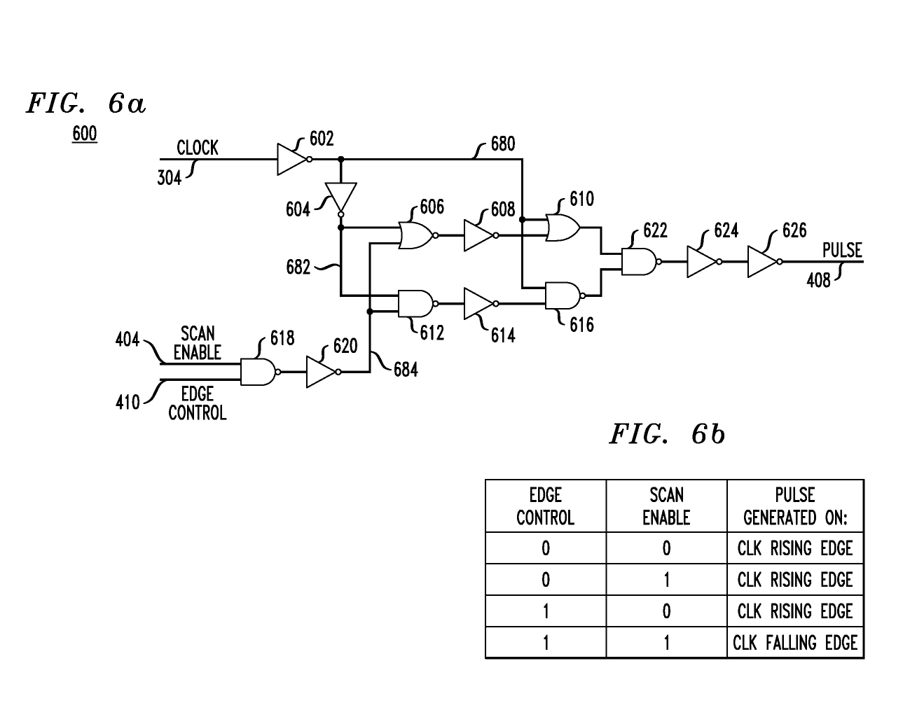

FIG. 3b shows an associated timing diagram of clock signal 304, pulse signal 308, input signal 302 and output signal 312 employed with pulse-triggered latch cell 300. Based upon clock signal 304, pulse generator 306 generates pulse signal 308. Pulse signal 308 is generated such that the pulse duration is long enough to avoid setup time violations, but short enough to avoid hold time violations. As shown in FIG. 3b, pulse signal 308 is referenced to the positive edge of clock signal 304; however, embodiments of the present invention provide that pulse signal 308 might be selectably referenced to either the positive or negative edge of clock signal 304. Pulse generator 306 is described subsequently with regard to FIGS. 6a and 6b. Output signal 312 at Q only changes to the value of input signal 302 at D when pulse signal 308 goes logic high. As shown in FIG. 3b, clock signal 304 goes high at transition 320. Pulse signal 308 goes high at transition 322, which is delayed relative to clock signal 304 since pulse generator 306 might introduce some propagation delay. Output signal 312 changes state at transition 324, which might be delayed from transition 322.

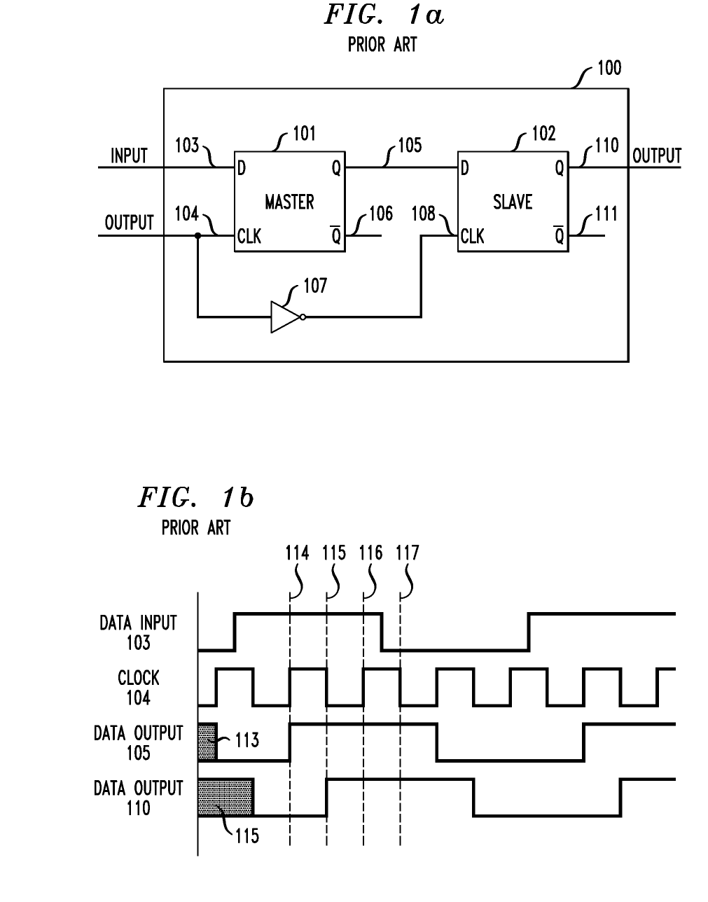

Power dissipation of a logic circuit utilizing pulse-triggered latch cells 300 might be reduced when compared to a logic circuit using standard master-slave flip-flops since, as shown, pulse-triggered latch cell 300 includes only one latch, latch 310, while a master-slave flip-flop contains two latches, as shown in FIG. 1a. Further, by utilizing pulse generator 306 to clock one or more pulse-triggered latches 310 within a logic design, overall power dissipation of the clock network might be reduced because fewer clock lines are needed.

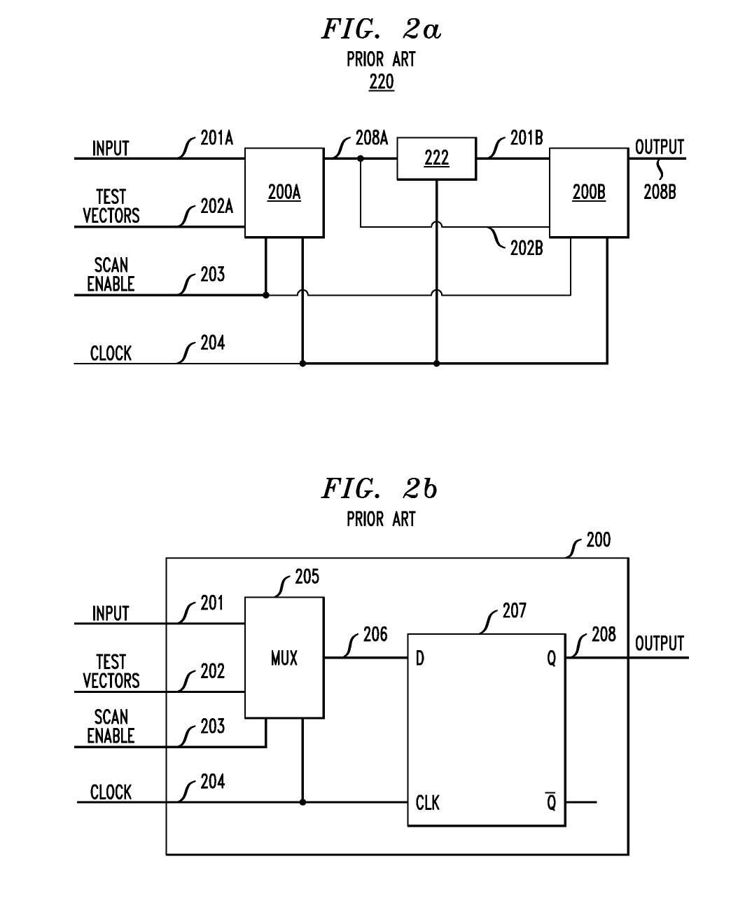

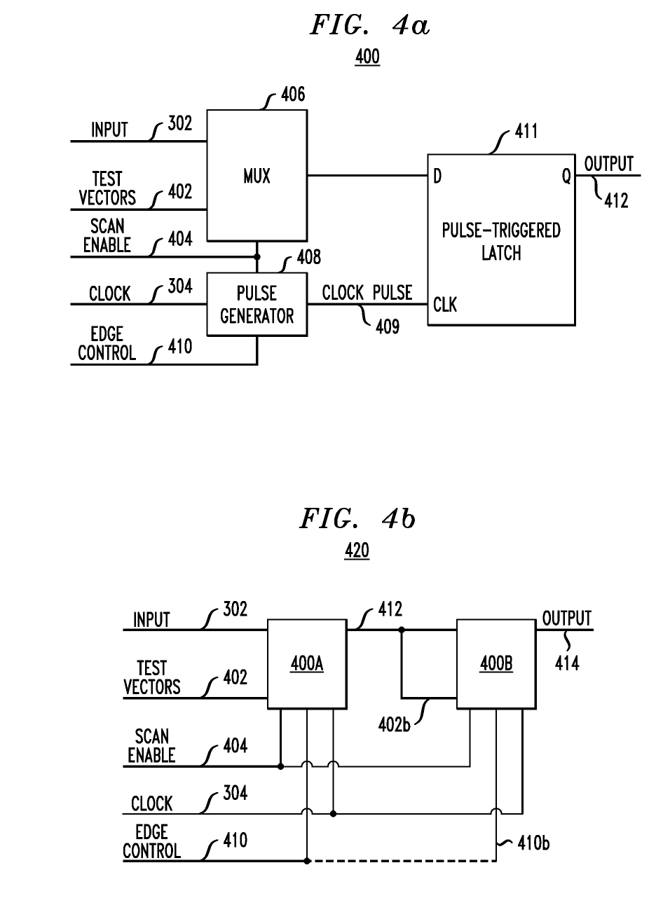

FIG. 4a shows a pulse-triggered latch 400 implemented with a scan function (“scan latch”). As shown in FIG. 4a, scan latch 400 includes at least one pulse-triggered latch, shown as pulse-triggered latch 310. Scan latch 400 receives data input signal 302 and clock signal 304, similarly as described with regard to FIGS. 3a and 3b. Scan latch 400 also receives scan enable signal 404 and test vector signal 402, similarly as described with regard to FIGS. 2a and 2b. Scan latch 400 also receives control signal sc2 410. Data input signal 302, test vector signal 402 and scan enable signal 404 are provided to multiplexer 406. Multiplexer 406 is configured to output one of data input signal 302 or test vector signal 402, based on the value of scan enable signal 404. For example, when a scan test takes place, scan enable signal 404 might be asserted high, and multiplexer 406 might output test vector signal 402. The output of multiplexer 406 is provided to pulse-triggered latch 411. Clock signal 304 is provided to pulse generator 408. Pulse generator 408 also receives edge control signal 410 and scan enable signal 404. Pulse generator 408 outputs pulse signal 409. Operation of pulse generator 408 is described further below with regard to FIGS. 6a and 6b. Pulse signal 409 is provided to pulse-triggered latch 310. The output signal, 412, of pulse-triggered latch 411 is provided as the output of scan latch 400.

FIG. 4b shows a scan chain, 420, implemented with a plurality of scan latches 400 as shown in FIG. 4a. As shown in FIG. 4b, scan chain 420 might include two scan latches, shown as scan latch 400A and scan latch 400B; however the invention is not limited only to two scan latches. As shown, scan chain 420 includes two exemplary scan latches, 400A and 400B. As shown, scan latch 400A receives data input signal 302, test vector signal 402a, scan enable signal 404, clock signal 304, and edge control signal 410. Scan latch 400A provides output signal 412.

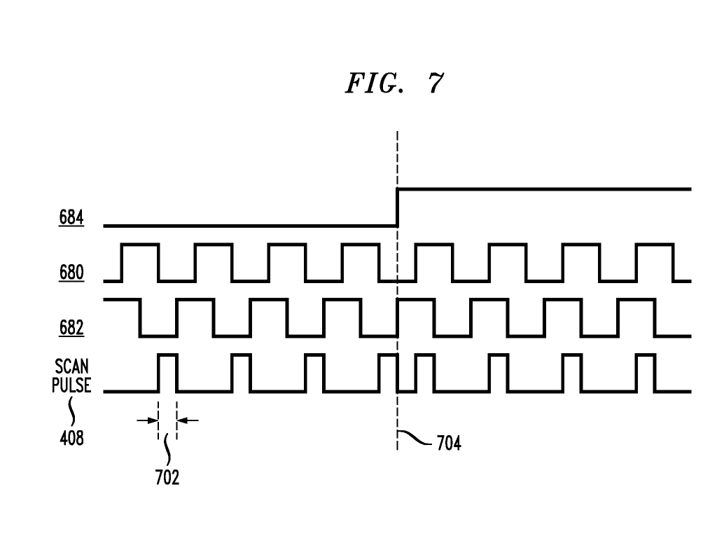

Scan latch 400B provides output signal 414. Scan latch 400B receives output signal 412 from scan latch 400A as its data input. As shown, scan latch 400B might receive output signal 412 as its test vector input, shown as 402b. Alternatively, scan latch 400B might be configured to receive a test vector signal at test vector input 402b from a different source than output signal 412 from scan latch 400A. This test vector signal might be substantially equivalent to test vector signal 402 received by scan latch 400A. Scan latch 400B also receives scan enable signal 404 and clock signal 304. As shown, scan latch 400B also receives an edge control signal 410b. Edge control signal 410b might, as indicated by the dashed line, be the same edge control signal, 410, as received by scan latch 400A. Alternatively, scan latch 400A and scan latch 400B might receive separate edge control signals allowing for individual control of each scan latch. Edge control signal 410 is described in greater detail below with regard to FIGS. 6 and 7.

In operation, scan chain 420 provides a technique for applying a test vector signal (e.g. test vector signals 402a and 402b) to one or more pulse-triggered latches. The pulse-triggered latches are coupled together in sequence as shown in FIG. 4b such that scan data flows from a first scan latch (e.g. scan latch 400A) to subsequent scan latches (e.g. scan latch 400B, etc.) with each clock cycle of clock signal 304. With prior art latches, a scan chain might not be easily formed since each latch would be “data transparent,” allowing input data to flow through in one clock cycle. However, in accordance with embodiments of the present invention, if scan latch 400A and scan latch 400B are configured to be triggered at opposite edge transitions of clock signal 304, such data transparency does not occur and a scan chain can be formed. For example, scan latch 400A might be configured to be triggered at a low-to-high edge transition of clock signal 304, and scan latch 400B might be configured to be triggered at a high-to-low edge transition of clock signal 304 to implement scan chain 420. In embodiments of scan chain 420 that include more than two scan latches, the triggering edge of clock signal 304 might continue to alternate with every other scan latch as described above. Embodiments of the present invention might employ edge control signal 410 to configure which edge transition is used to trigger each scan latch, as will be described subsequently with regard to FIGS. 6 and 7.

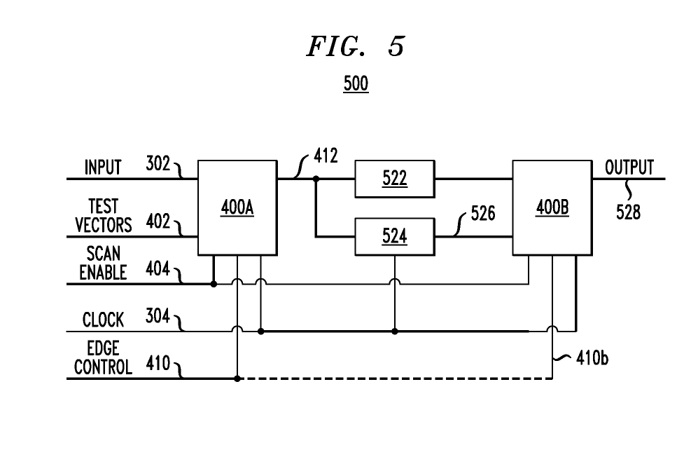

FIG. 5 shows an alternative embodiment 500, of a scan chain such as scan chain 420 of FIG. 4b. Similarly as shown in FIGS. 4a and 4b, scan latch 400A receives data input signal 302, test vector signal 402, scan enable signal 404, clock signal 304, and edge control signal 410. Scan latch 400A provides output signal 312. Scan latch 400B might receive output signal 312 as its data input, or, as shown, output signal 312 might be provided to intermediate logic circuit 522 whose output is provided as the data input to scan latch 400B. Scan latch 400B also receives scan enable signal 404 and clock signal 304. As shown, scan latch 400B also receives a control signal 410b. As described with regard to FIG. 1, a scan test might allow signals to propagate very quickly between scan latches 400A and 400B because an intermediate logic circuit 522 between the scan latches might be bypassed during the scan test. Thus, embodiments of the present invention provide for delay cell 524 to be inserted in the signal path between scan latches 400A and 400B when a scan test is performed. As shown, output signal 312 from scan latch 400A is provided to delay cell 524. Delay cell 524 generates a delayed output signal 526 based on signal 312. Delayed output signal 526 is provided to the test vector input of scan latch 400B. Delay cell 524 might be implemented as one or more signal buffers adapted to delay signal 312.

FIG. 6a shows a pulse generator 600 in accordance with an exemplary embodiment of the present invention. As shown, pulse generator 600 receives clock signal 304, scan enable signal 404 and edge control signal 410. As shown in the truth table of FIG. 6b, pulse generator 600 is generally configured, for both normal operation (when scan enable signal 404 is logic low) and scan tests (scan enable signal 404 is logic high), to generate pulse signal 408 on a rising edge transition of clock signal 304. However, as described above, during a scan test it might be desirable to trigger some latches on a falling edge transition of clock signal 304. Thus, when edge control signal 410 is asserted high and a scan test is enabled (scan enable signal 404 is logic high), pulse generator 600 is configured to generate pulse signal 408 on the falling edge of clock signal 304. In some embodiments, pulse generator 600 might provide both inverted and non-inverted scan pulse signals.

FIG. 7 shows a timing diagram of pulse signal 408 in reference to control signal 684 and clock signals 680 and 682, as shown in FIG. 6a. Control signal 684 is provided by inverter 620 and NAND gate 618. NAND gate 618 has edge control signal 410 and scan enable signal 404 as inputs. When both scan enable signal 404 and edge control signal 410 are asserted logic high, control signal 684 is high (e.g. pulse signal 408 is generated for falling edges for a scan test). Otherwise, control signal 684 is low (e.g. pulse signal 408 is generated for rising edges for normal operation or for a scan test). Clock signal 304 is inverted by inverter 602 to provide inverted clock signal 680. Inverted clock signal 680 is inverted again by inverter 604 to provide clock signal 682. One or more additional inverters might be employed to provide additional signal propagation delay in the circuit. Additionally, inverter 604 and gates 606 and 608, or inverter 604 and gates 612 and 614, introduce delay between clock signal 680 and clock signal 682 (shown in FIG. 7 as time delay 702). As shown, the duration of time delay 702 substantially determines the duration of the pulse of pulse signal 408. Thus, for pulse signal 408 to be generated such that the pulse duration is long enough to avoid setup time violations, but short enough to avoid hold time violations, the delay between clock signal 680 and clock signal 682 is adjusted.

As shown in FIG. 7, when control signal 684 is logic low, pulse signal 408 is generated on a rising edge of clock signal 304. When control signal 684 is logic low, pulse signal 408 is generated through the circuit path in FIG. 6a of NOR gate 606, inverter 608, OR gate 610, NAND gate 622, and inverters 624 and 626. As shown in FIG. 7, this circuit path operates such that pulse signal 408 is logic high whenever both clock signal 680 and clock signal 682 are logic low, which corresponds to the rising edge of clock signal 304. Alternatively, when control signal 684 is logic high, pulse signal 408 is generated on a falling edge of clock signal 304. When control signal 684 is logic high at transition 704, pulse signal 408 is generated through the circuit path of NAND gate 612, inverter 614, NAND gate 616, NAND gate 622, and inverters 624 and 626. As shown in FIG. 7, this circuit path operates such that pulse signal 408 is logic high whenever both clock signal 680 and clock signal 682 are logic high, which corresponds to the falling edge of clock signal 304. Thus, embodiments of pulse generator 600 selectably provide a pulse signal output on either the rising or falling edge of the clock input signal. As described above with regard to FIG. 4b, embodiments of the present invention provide pulse-triggered latches with scan functionality by employing a plurality of such pulse generators, wherein a pulse generator for a first scan latch is configured to generate pulses at one edge of the clock signal, and a pulse generator for a subsequent scan cell is configured to generate pulses at the other edge of the clock signal, thus avoiding data transparency and forming a scan chain.

As described above, conventional latches are generally sensitive to propagation delays on the clock signal, and variations in chip layout might cause propagation delays in the clock signal. Pulse-triggered latches, such as shown in FIGS. 3a and 4a, might be sensitive to propagation delays in the pulse clock signal. During the design of an integrated circuit, conventional placement and routing (P&R) tools might cause the pulse generator and latches to be located at various locations on the IC, at varying distances from each other, which would affect timing. Therefore, an embodiment of the present invention provides a pulse-triggered latch cell, such as shown in FIGS. 3a and 4a, which is added as a library component to a P&R tool. The pulse-triggered latch cell library component includes the pulse generator in an integral module with one or more pulse-triggered latches. Thus, the pulse generator is not moved around in the physical chip layout, and the pulse clock timing might be maintained within desired tolerances. In general, a P&R tool might be a computer aided design (CAD) software program running on a general purpose computer.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processes of circuits, including possible implementation as a single integrated circuit, a multi-chip module, a single card, or a multi-card circuit pack, the present invention is not so limited. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bit stream or other sequence of signal values electrically or optically transmitted through a medium, stored magnetic-field variations in a magnetic recording medium, etc., generated using a method and/or an apparatus of the present invention.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A scan chain having at least one pulse-triggered latch scan cell, the scan cell comprising:
a pulse-triggered latch adapted to latch data present at its input terminal to its output terminal based on a clock pulse applied to its clock terminal; and
a pulse generator adapted to generate the clock pulse from either a rising edge or a falling edge of a clock signal based on a control signal.

2. The invention of claim 1, wherein the pulse generator comprises a logic circuit comprising:
a first circuit path adapted to provide the rising edge-generated clock pulse on a rising edge of the clock signal; and
a second circuit path adapted to provide the falling edge-generated clock pulse on a falling edge of the clock signal.

3. The invention of claim 2, wherein the pulse generator further comprises:
at least one delay cell adapted to provide a delayed clock signal;
an inverter adapted to provide an inverted clock signal;
wherein the first circuit path comprises:
first digital logic circuitry adapted to provide, based on a first state of the control signal, the rising edge-generated clock pulse when the delayed clock signal and the inverted clock signal are in a first combination; and
wherein the second circuit path comprises:
second digital logic circuitry adapted to provide, based on a second state of the control signal, the falling edge-generated clock pulse when the delayed clock signal and the inverted clock signal are in a second combination.

4. The invention of claim 1, further comprising:
a multiplexer adapted to provide either a data input signal or a test vector signal as data to the pulse-triggered latch based on the value of a control signal, the control signal enabling a scan function of the pulse-triggered latch scan cell,
wherein, for a normal operation of the pulse-triggered latch scan cell, the multiplexer provides the data input signal to the pulse-triggered latch, and wherein, for a scan operation, the multiplexer provides the test vector signal to the pulse-triggered latch.

5. The invention of claim 4, wherein the test vector signal is an automatic test-pattern generation (ATPG) signal.

6. The invention of claim 1, wherein the scan chain comprises a plurality of pulse-triggered latch cells in a sequence.

7. The invention of claim 6, wherein a first pulse-triggered latch scan cell is clocked with a rising edge-generated clock pulse and wherein a second pulse-triggered latch scan cell is clocked with a falling edge-generated clock pulse, the input terminal of the second pulse-triggered latch scan cell coupled to the output terminal of the first pulse-triggered latch scan cell.

8. The invention of claim 1, wherein the scan chain is implemented in an integrated circuit (IC) chip.

9. A pulse-triggered latch scan chain having two or more pulse-triggered latch scan cells coupled in series, wherein each pulse-triggered latch scan cell comprises:
a pulse-triggered latch adapted to latch data present at its input terminal to its output terminal based on a clock pulse applied to its clock terminal; and
a pulse generator adapted to generate the clock pulse from either a rising edge or a falling edge of a clock signal based on a control signal, and
wherein the control signal sets a timing delay between each clock pulse applied to a corresponding pulse triggered latch in the series by selecting either the rising edge or the falling edge of the clock signal.

10. The invention of claim 9, further comprising:
a multiplexer adapted to provide either a data input signal or a test vector signal as data to the pulse-triggered latch based on the value of a control signal, the control signal enabling a scan function of the pulse-triggered latch scan cell,
wherein, for a normal operation of the pulse-triggered latch scan cell, the multiplexer provides the data input signal to the pulse-triggered latch, and wherein, for a scan operation, the multiplexer provides the test vector signal to the pulse-triggered latch.

11. The invention of claim 10, wherein the output signal of a first scan cell in the series is provided as both the data input signal and the test vector input signal to a second scan cell in the sequence.

12. The invention of claim 11, wherein a delay cell is inserted between scan cells in the series.

13. The invention of claim 11, wherein a logic circuit between scan cells in the sequence is bypassed during a scan test.

14. The invention of claim 9, wherein the pulse generator logic circuit comprises:
a first circuit path adapted to provide the rising edge-generated clock pulse on a rising edge of the clock signal; and
a second circuit path adapted to provide the falling edge-generated clock pulse on a falling edge of the clock signal.

15. The invention of claim 14, wherein the pulse generator further comprises:
at least one delay cell adapted to provide a delayed clock signal;
an inverter adapted to provide an inverted clock signal;
wherein the first circuit path comprises:
first digital logic circuitry adapted to provide, based on a first state of the control signal, the rising edge-generated clock pulse when the delayed clock signal and the inverted clock signal are in a first combination; and
wherein the second circuit path comprises:
second digital logic circuitry adapted to provide, based on a second state of the control signal, the falling edge-generated clock pulse when the delayed clock signal and the inverted clock signal are in a second combination.

16. The invention of claim 15, wherein the at least one delay cell is adapted to determine the width of the clock pulse.

17. A pulse-triggered latch scan chain comprising:
a plurality of pulse-triggered latch scan cells, wherein the pulse-triggered latch scan cells are connected in series, and wherein the pulse-triggered latch scan cells comprise:
a pulse-triggered latch adapted to latch data present at its input terminal to its output terminal based on a clock pulse applied to its clock terminal;
a multiplexer adapted to provide either a data input signal or a test vector signal as data to the pulse-triggered latch based on the value of a first control signal, the first control signal enabling a scan function of the pulse-triggered latch scan cell,
a pulse generator adapted to generate the clock pulse from either a rising edge or a falling edge of a clock signal, based on the value of a second control signal,
wherein, for a normal operation of the pulse-triggered latch scan cell, the multiplexer provides the data input signal to the pulse-triggered latch, and wherein, for a scan operation, the multiplexer provides the test vector signal to the pulse-triggered latch.

18. The invention of claim 17, wherein the pulse generator further comprises:
a first circuit path adapted to provide the rising edge-generated clock pulse on a rising edge of the clock signal, wherein the first circuit path comprises:
first digital logic circuitry adapted to provide, based on a first state of the second control signal, the rising edge-generated clock pulse when the delayed clock signal and the inverted clock signal are in a first combination;
a second circuit path adapted to provide the falling edge-generated clock pulse on a falling edge of the clock signal, wherein the second circuit path comprises:
second digital logic circuitry adapted to provide, based on a second state of the second control signal, the falling edge-generated clock pulse when the delayed clock signal and the inverted clock signal are in a second combination;
at least one delay cell adapted to provide a delayed version of the system clock signal; and
an inverter adapted to provide an inverted version of the system clock signal,
wherein, the second control signal sets a timing delay between each clock pulse applied to a corresponding pulse triggered latch in the series by selecting either the rising edge or the falling edge of the clock signal.

19. The invention of claim 18, wherein the at least one delay cell is adapted to determine the width of the clock pulse.
